(19) United States
(12) Patent Application Publication
(10) Pub. No.: US 2006/0064318 A1
(43) Pub. Date: Mar. 23, 2006

(54) Method for managing a metric for use on a diagnostic medical modality and apparatus and method for conducting a medical investigation

(75) Inventors: Yasser Alsafadi, Yorktown Heights, NY (US); Octav Chipara, Bloomington, IN (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/537,873

(22) PCT Filed: Dec. 11, 2003
(86) PCT No.: PCT/IB03/05969

§ 371 Date: Jun. 7, 2005

Related U.S. Application Data
(60) Provisional application No. 60/434,575, filed on Dec. 19, 2002.

(51) Int. Cl. G06Q 50/00

(52) U.S. Cl. 705/2

(57) ABSTRACT

A method (200) for remotely managing a metric (12) adapted for use on a diagnostic medical modality (21) is provided. The diagnostic medical modality (21) is responsive to a software program (38) which, when executed, causes the diagnostic medical modality (21) to conduct a medical investigation based on the metric (12). The method (200) includes retrieving (202) via the World Wide Web (18) a metric (12) associated with the diagnostic medical modality (21); verifying (204) the integrity of the metric (12); and downloading the metric (12) to the diagnostic medical modality (21). The method (200) may be implemented by a computer-readable storage medium having stored thereon one or more software programs (24) which, when executed, implement the method.

Aspects of this invention relate generally to metric management for diagnostic medical systems, and, more particularly, to a method for remotely managing a metric for use on a diagnostic medical modality, and to an apparatus and method for conducting a medical investigation using a diagnostic medical modality.

Traditionally, medical systems, or modalities, such as x-ray systems, cardiographs, magnetic resonance imaging systems, ultrasounds, computed tomography scanners, and position emission tomography systems, among others, have consulted extrinsic sources of information, in addition to empirical measurements, to conduct clinical medical investigations.

Extrinsic information used by medical modalities includes, among other things, accepted criteria, or metrics, for evaluating the results of calculations performed during medical investigations conducted by the medical modalities. Evaluations of calculated results may be used by a medical modality for, among other things, differentiation of diagnoses, and building decision support for the medical modality.

A norm is a type of metric used by a medical modality. A norm is typically a text file, used in conjunction with empirical measurements made by the medical modality, which indicates normal values of a medical conclusion for specific ranges of empirical measurements and predetermined inputs. An ultrasound machine, for example, utilizes a norm file to determine whether a medical conclusion like an estimated fetal weight is within a normal range for a given fetal age, based on a measurement of the fetal abdominal circumference by the ultrasound machine.

Typically, metrics such as norms are integrated with software residing on a particular medical modality. The integration of metrics with local software presents challenges to manufacturers and customers of medical modalities. When norms are updated, for example, new software releases may be required. Moreover, local norm modifications may not be preserved across software releases.

On general-purpose computers, client-server architectures and modular programming techniques allow some local computer software components to be replaced by components obtained from remote computers. Local general-purpose computers may also retrieve data from remote computers. An information service such as the World Wide Web, for example, uses standard protocols to allow computer users with a browser application to retrieve data from computer networks such as the Internet. Such architectures and techniques, however, have not been generally adapted for use on specific-purpose diagnostic medical modalities to address design and operational inefficiencies of such modalities in clinical settings.

There is, therefore, a need for methods of managing metrics adapted for use on diagnostic medical modalities, which utilize features such as modular software programming, client-server architectures and the World Wide Web.

According to an aspect of the present invention, the foregoing need is addressed by a method for remotely managing a metric adapted for use on a diagnostic medical modality. The diagnostic medical modality is responsive to a software program which, when executed, causes the diagnostic medical modality to conduct a medical investigation based on the metric. The method includes retrieving via the World Wide Web a metric associated with the diagnostic medical modality; verifying the integrity of the metric; and downloading the metric to the diagnostic medical modality. The method may be implemented by a computer-readable storage medium having stored thereon one or more software programs which, when executed, implement the method.

According to another aspect of the present invention, a method for conducting a medical investigation using a diagnostic medical modality is provided. The diagnostic medical modality is responsive to a metric, responsive to a software program which, when executed, causes the diagnostic medical modality to conduct the medical investigation based on the metric, and responsive to a web server. The method includes requesting the metric from the web server; based on the request, retrieving the metric from the web server and recognizing the metric on the diagnostic medical modality; and causing the execution of the software program based on the recognized metric. The method may be implemented by a computer-readable storage medium having stored thereon one or more software programs which, when executed, implement the method.

According to a further aspect of the present invention, an apparatus for conducting a medical investigation includes a computer-readable storage medium, responsive to a diagnostic medical modality, for storing a metric automatically downloadable to the diagnostic medical modality from the World Wide Web. The metric includes predetermined criteria for performing a clinical medical calculation in connection with the medical investigation. A processor is responsive to the computer-readable storage medium and to a software program, and the software program, when loaded into the processor, is operative to cause the diagnostic medical modality to conduct the clinical medical calculation based on the metric.

According to a still further aspect of the present invention, a method of providing a service for managing a metric associated with a diagnostic medical modality includes providing, in a computer-readable storage medium, a plurality of metrics associated with a plurality of diagnostic medical modalities, the metrics comprising predetermined criteria for performing clinical medical calculations using diagnostic medical modalities; prior to at least one of the plurality of diagnostic medical modalities performing a clinical medical calculation, causing at least one of the plurality of metrics to be automatically downloaded to the at least one diagnostic medical modality via the World Wide Web; and causing the at least one diagnostic medical modality to perform the clinical medical calculation based on the downloaded metric.

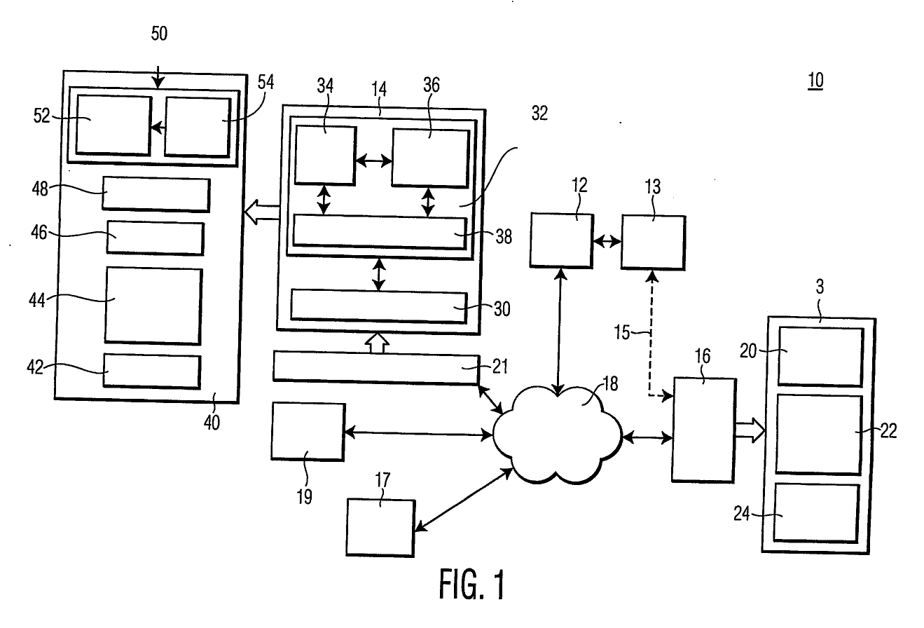

FIG. 1 illustrates a web-enabled architecture for remotely managing metrics adapted for use on diagnostic medical modalities, in accordance with an aspect of the present invention.

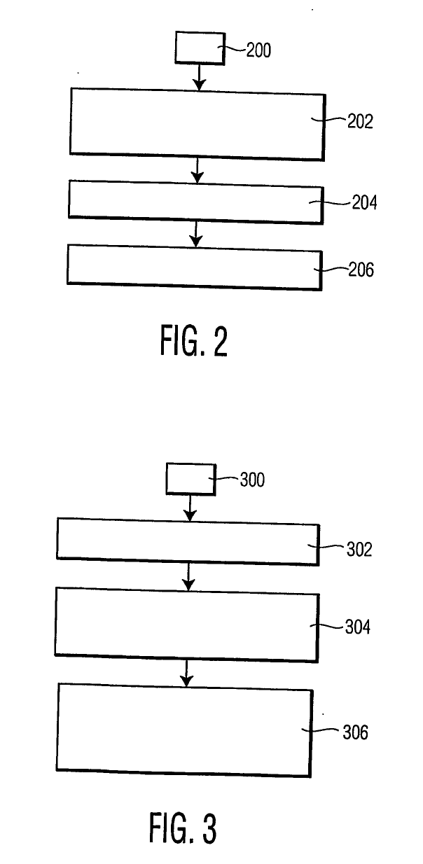

FIG. 2 is a flowchart of a method for remotely managing a metric for use on a diagnostic medical modality, in accordance with an aspect of the present invention.

FIG. 3 is a flowchart of a method for conducting a medical investigation using a diagnostic medical modality, in accordance with another aspect of the present invention.

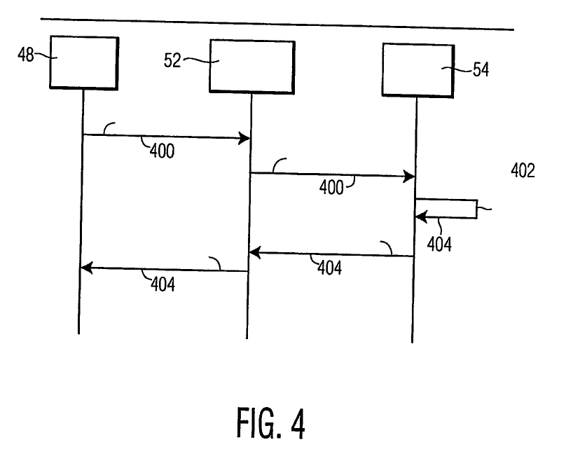

FIG. 4 illustrates backward-chaining techniques used to conduct medical investigations using diagnostic medical modalities, in accordance with further aspects of the present invention.

Turning now to the drawings, wherein like numerals designate like components, FIG. 1 illustrates an architecture 10 for remotely managing metrics adapted for use on diagnostic medical modalities.

Medical modalities 17, 19 and 21 are preferably different types of diagnostic medical systems, for example, x-ray systems, cardiographs, magnetic resonance imaging systems, ultrasounds, computed tomography scanners, and position emission tomography systems.

As shown in further detail by block diagram 14, medical modality 21 includes a hardware engine 30 and a run-time engine 32. Hardware engine 30 encompasses devices associated with medical modality 21 used by technicians to conduct medical investigations, that is, to gather empirical data and to make measurements during operation of medical modality 21. Run-time engine 32 encompasses signal processing-type activity associated with medical modality 21 during a medical investigation.

Run-time engine 32 includes a computer-readable storage medium 34, such as a memory, and a processor 36 responsive to computer-readable storage medium 34. An example of a suitable run-time engine is a web server. Multiple storage media, processors and configurations of such devices are possible, however, such devices and configurations being well-known and commercially available, and adaptable by those of ordinary skill in the art for use in connection with specific-purpose medical modalities.

Processor 36 and computer-readable storage medium 34 are further responsive to a software program 38, operative to cause medical modality 21 to perform medical investigations. Software program 38 is preferably organized into functional software components, each software component operative to implement one or more related functions, or rules. Software program 38 is functionally illustrated by component stack 40 (discussed further below).

Metrics 12 are preferably norms—text files used in conjunction with empirical measurements made by medical modalities 17, 19 and 21, which indicate normal values of medical conclusions for specific ranges of empirical measurements and predetermined inputs. Metrics 12, however, may be any type of information, including but not limited to clinical guidelines, protocols and any other information useful for operation of medical modalities 17, 19 and 21. Metrics 12 are preferably located on one or more computer-readable storage media 13, such media being well-known and commercially available, which may be geographically co-located with, or responsive to (via protocol 15, for example), metric management service 16 (discussed further below) or, as shown, remote from metric management service 16 and responsive thereto via World-Wide Web 18 (discussed further below) or another suitable communication protocol.

A central metric management service 16 for managing metrics 12 is responsive to medical modalities 17, 19 and 21 and metrics 12 via the World Wide Web information service 18 of the Internet (not shown).

Metric management service 16 is preferably provisioned using one or more web servers, but any type of server adapted to respond to remote computer networks via World Wide Web 18 is suitable. The geographic location of metric management service 16 may be a business decision of the entity (such as a manufacturer, hospital, other service provider or combination of service providers) responsible for managing metrics 12 and/or medical modalities 17, 19 and 21. As such, metric management service 16 may include a single server or group of servers in one or more geographic locations, and the servers may be remotely located from, or co-located with, metrics 12 and/or medical modalities 17, 19 and 21.

Metric management service 16 is functionally illustrated by component stack 3, which includes web service software 24, master knowledge base 22, and integrity checker 20.

Web service software 24 is preferably a modular software program which, when executed, is capable of causing metric management service 16 to retrieve and download metrics 12 to medical modalities 17, 19 and 21, and to master knowledge base 22, via World-Wide Web 18.

Master knowledge base 22, responsive to web service software 24, and to a central technician (not shown) for maintenance purposes, represents a master list of metrics 12, along with other data and information useful for providing metric management service 16, for medical modalities 17, 19 and 21. Metrics 12 are preferably associated with specific medical modalities 17, 19 and 21 using unique medical modality identifiers. Master knowledge base 22 may be a database, a collection of links to remote information, or any other suitable means of storing and referencing data and information, such means being generally well-known and commercially available.

Integrity checker 20 corresponds to the function of verifying the accuracy of information, such as metrics 12, in master knowledge base 22, and is preferably implemented as a software module by web service software 24. Integrity checker 20 identifies or corrects errors in metrics 12, to prevent error propagation to medical modalities 17, 19 and 21.

Returning to run-time engine 32 associated with medical modality 21, run-time engine 32 in general, and software program 38 in particular, is functionally illustrated by component stack 40, which includes web interface 42, local knowledge base 44, plug-in factory 46, rule execution engine 48, and application 50.

Web interface 42 is responsive to, and responsible for, communication between metric management service 16 and medical modality 21. The primary function of web interface 42 is to request and receive one or more metrics 12 in serialized form from metric management service 16, and to direct received metrics 12 to local knowledge base 44.

Communication between metric management service 16 and medical modality 21 preferably occurs via Simple Object Access Protocol (“SOAP”), and metrics 12 may be serialized in XML format prior to being downloaded to medical modality 21. Those skilled in the art will appreciate that a generic mechanism for serializing metrics 12 may be generated, as current implementations of SOAP are able to serialize JavaBeans automatically.

Local knowledge base 44, responsive to web interface 42 and application 46, represents a local list of metrics 12, along with other data and information, used by a particular medical modality 21. Local knowledge base 44 may be a database, a collection of links to information, or any other suitable means of storing and referencing information, such means being generally well-known and commercially available.

Application 46 is a functional representation of the signal processing-type activity that occurs within a specific medical modality 21 to enable a medical investigation. Application 46 preferably includes multiple software components which, collectively, comprise plug-in factory 48. Application 46, and plug-in factory 48, may be implemented according to well-known software engineering practices for component-based software development. Component-based software development allows for re-use of software components, shortens software development cycles, and simplifies software debugging and testing.

Software components comprising plug-in factory 48 communicate with each other via rule execution engine 50, which is an event-based, or rules-based, system, and which may also be a software component of plug-in factory 48. In the abstract, rule execution engine 50 maintains multiple rules (discussed further below), and is functionally illustrated by an event dispatcher component 52 and an event handler component 54.

A rule (not shown) maintained by rule execution engine 50 includes two parts: a trigger and a set of actions based on the trigger. For example, a rule may define how to use metrics 12 during a medical investigation on medical modality 21, and/or which software component comprising 48 should be invoked, based on a particular trigger. When a trigger occurs for a rule maintained by rule execution engine 50, event dispatcher 52 acts by invoking one or more software component within plug-in factory 48. A software component invoked by event dispatcher 52 is referred to as event handler 54.

FIG. 2 is a flowchart of a method, preferably implemented by metric management system 16, for remotely managing metric 12 adapted for use on medical modality 21, in accordance with an aspect of the present invention. The method starts at block 200 and continues at block 202, where metric 12 associated medical modality 21 is retrieved from World Wide Web 18. Metrics 12 may be retrieved from master knowledge base 22 based on a unique identifier of medical modality 21. At block 204, the integrity of metric 12 is verified, and metric 12 is downloaded to medical modality 21 at block 206.

To initiate retrieval of metric 12, medical modality 21 may send a request (not shown) to metric management system 16 for an updated metric 12, or set of metrics. Alternatively, metric management service 16 may automatically initiate downloading of updated metrics 12 to medical modality 21, as updated metrics 12 become available, or according to another predetermined schedule.

In accordance with another aspect of the present invention, FIG. 3 is a flowchart of a method for conducting a medical investigation using medical modality 21, which is responsive to a software program, such as application 46, which uses one or more metrics 12 to direct signal processing activity of medical modality 21 during the medical investigation. The method starts at block 300 and continues at block 302, where metric 12 is requested from a web server. It is contemplated that this request may be made via application 46 to a local web server, such as run-time engine 32, or via run-time engine 32 to a remote web server, such as metric management service 16. When requesting metric 12 from a remote web server, medical modality 21 may utilize a unique identifier. At block 304, metric 12 is retrieved from the web server and recognized on medical modality 21. The software program is executed, at block 306, and causes medical modality 21 to perform the medical investigation using recognized metric 12.

To reach desired medical conclusions, it may be necessary to use rules to compute or estimate certain variables using metric 12, in conjunction with empirical data, or measurements, gathered by medical modality 21. When such computation or estimation is necessary, either forward-chaining or backward-chaining techniques may be used. Backward-chaining techniques are preferably employed in accordance with the various aspects of the present invention.

FIG. 4 illustrates backward-chaining techniques used to conduct a medical investigation using medical modality 21 and metric 12, in accordance with further aspects of the present invention. During operation of medical modality 21, a plug-in software component (not shown) within plug-in factory 48, which is associated functionally with application 46, is invoked, and sends a request 400 to rules execution engine 50, requesting estimation of a value dependent on both a measurement taken by medical modality 21 and metric 12. Event dispatcher 52 consults known rules (not shown), to determine if request 400 is a rule trigger, and based on the rules triggered, propagates request 400 to a specific event handler(s) 54. Event handler(s) 54 executed triggered rule(s) 402, estimated value 404 is returned to event dispatcher 52. Event dispatcher 52 returns estimated value 404 to plug-in factory 48.

A triggered rule 402, “Estimate Value,” for estimating a value dependent on both a measurement taken by medical modality 21 and metric 12, may be modeled using the following pseudo-code:
EstimateValue(value)
   N=Get local metric(value)
   D=Get value dependencies(N)
   For each D
      If D is NOT computed
         If D is a measurement then the value cannot be computed
         Else EstimateValue(D)
   If all dependencies computed, then compute value using N.

An ultrasound machine, for example, may utilize a metric, such as a norm file, to determine whether a medical conclusion like an estimated fetal weight is within a normal range for a given fetal and maternal age, based on measurements, such as the fetal abdominal circumference, made by the ultrasound machine. Prior to estimating the fetal weight, the ultrasound machine would retrieve the norm file related to the estimation. Using the norm file and measurements such as fetal abdominal circumference, among others, the estimated fetal weight would be computed using backward chaining.

The architectures and methods described herein allow for separate maintenance of metrics and software programs responsive to diagnostic medical modalities. Greater design and operational efficiencies for medical modalities, as well as new business models, may be realized based on various aspects of the present invention.

Although architecture 10 has been described herein in terms of specific functional elements and relationships, it is contemplated that architecture 10 may be configured in a variety of ways. For example, functional elements may be packaged together or individually, or may be implemented by fewer, more or different devices, and may be either integrated within medical modalities or adapted to work with individual medical modalities. Further, when one element is indicated as being responsive to another element, the elements may be directly or indirectly coupled.

With respect to implementation of certain aspects of the invention, the methods described herein may be implemented using computer software stored on any computer-readable medium (or electronically), or using firmware, or using software, or any combination thereof. In addition, such aspects of the invention are not limited to any specific embodiments of computer programs or signal processing methods.

Although the World Wide Web has been specifically referred to herein, the embodiments of present invention are applicable to architectures described by different specifications, and responsive to different infrastructures and tools (for example, discrete storage media such as compact disks or diskettes may be used to update and provide metrics to a medical modality), and the principles of the embodiments of the present invention applicable to diagnostic medical modalities may also apply to other types of specific-purpose systems.

It will furthermore be apparent that other and further forms of the invention, and embodiments other than the specific embodiments described above, may be devised without departing from the spirit and scope of the appended claims and their equivalents, and therefore it is intended that the scope of this invention will only be governed by the following claims and their equivalents.

1. A method (200) for remotely managing a metric (12) adapted for use on a diagnostic medical modality (21), the diagnostic medical modality (21) responsive to a software program (38) which, when executed, causes the diagnostic medical modality (21) to conduct a medical investigation based on the metric (12), the method comprising:
retrieving (202) via the World Wide Web (18) a metric (12) associated with the diagnostic medical modality (21);
verifying (204) the integrity (20) of the metric (12); and
downloading (206) the metric (12) to the diagnostic medical modality (21).

2. A computer-readable storage medium having stored thereon one or more software programs (24) which, when executed, implement the method of claim 1.

3. The method according to claim 1, further comprising:
based on a request from the diagnostic medical modality, retrieving the metric from the World Wide Web.

4. The method according to claim 1, wherein the metric is maintained at a central location.

5. The method according to claim 4, wherein the central location is one of:
a web server (3) responsive to a plurality of diagnostic medical modalities at multiple geographic locations; and
a web server (32) responsive to at least one diagnostic medical modality at a single geographic location.

6. The method according to claim 5, wherein the step of maintaining the metric further comprises:
automatically updating the metric prior to downloading the metric to the diagnostic medical modality.

7. The method according to claim 5, wherein the step of downloading the metric further comprises: automatically downloading an updated metric prior to conducting the medical investigation.

8. The method according to claim 5, wherein maintenance of the metric is separate from maintenance of the software program.

9. The method according to claim 1, wherein the metric comprises predetermined criteria for performing a medical calculation, the medical calculation comprising an output of the diagnostic medical modality.

10. A method (300) for conducting a medical investigation using a diagnostic medical modality (21), the diagnostic medical modality (21) responsive to a metric (12), responsive to a software program (38) which, when executed, causes the diagnostic medical modality (21) to conduct the medical investigation based on the metric (12), and responsive to a web server (32, 3), the method comprising:
requesting (302) the metric (12) from the web server (32, 3);
based on the request, retrieving (304) the metric (12) from the web server (32, 3) and recognizing the metric (12) on the diagnostic medical modality (21); and
causing the execution (306) of the software program (38) based on the recognized metric (12).

11. A computer-readable storage medium (34) having stored thereon one or more software programs which, when executed, implement the method of claim 10.

12. The method according to claim 10, wherein during the execution of the software program, substantially no interaction occurs between the diagnostic medical modality and the web server (3).

13. The method according to claim 10, wherein the step of requesting further comprises providing to the web server an identifier associated with the diagnostic medical modality.

14. The method according to claim 10, wherein the metric comprises predetermined criteria for performing a medical calculation, the medical calculation comprising an output of the diagnostic medical modality.

15. The method according to claim 14, wherein when the software program is executed, the diagnostic medical modality is caused to make a clinical measurement and, based on the clinical measurement and the metric, the medical calculation is performed and the diagnostic medical modality is caused to output the medical calculation.

16. The method according to claim 14, wherein when the software program is executed, the software program estimates a value associated with the medical calculation, the value being dependent on both a clinical measurement made by the diagnostic medical modality and the metric.

17. An apparatus for conducting a medical investigation, comprising:
a computer-readable storage medium (34), responsive to a diagnostic medical modality (21), for storing a metric (12) automatically downloadable to the diagnostic medical modality (21) from the World Wide Web (18), the metric (12) comprising predetermined criteria for performing a clinical medical calculation in connection with the medical investigation; and
a processor (36) responsive to the computer-readable storage medium (34) and to a software program (38), the software program (38), when loaded into the processor (36), operative to cause the diagnostic medical modality (21) to conduct the clinical medical calculation based on the metric (12).

18. A method of providing a service (16) for managing a metric (12) associated with a diagnostic medical modality (21), the method comprising the steps of:
providing, in a computer-readable storage medium (13), a plurality of metrics (12) associated with a plurality of diagnostic medical modalities (17, 19, 21), the metrics (12) comprising predetermined criteria for performing clinical medical calculations using diagnostic medical modalities (17, 19, 21);
prior to at least one of the plurality of diagnostic medical modalities (17, 19, 21) performing a clinical medical calculation, causing at least one of the plurality of metrics (12) to be automatically downloaded to the at least one diagnostic medical modality (21) via the World Wide Web (18); and
causing the at least one diagnostic medical modality (21) to perform the clinical medical calculation based on the downloaded metric (12).
